(19) United States
(12) Patent Application Publication
(10) Pub. No.: US 2014/0241561 A1
(43) Pub. Date: Aug. 28, 2014

(54) HEADPHONES

(71) Applicant: KEM HONGKONG LIMITED, Kowloon (HK)

(72) Inventor: Hideki Motosugii, Kanagawa (JP)

(73) Assignee: KEM HONGKONG LIMITED, Kowloon (HK)

(21) Appl. No.: 14/188,331

(22) Filed: Feb. 24, 2014

(30) Foreign Application Priority Data
Feb. 28, 2013 (JP) 2013-039973

(51) Int. Cl. H04R 1/10

(52) U.S. Cl. CPC H04R 1/105
USPC 381/379

(57) ABSTRACT

The invention pertains to headphones that can be folded into a compact size and carried around while they are out of use. To improve operability in collapsing and expanding operations, headphone units are attached to joint portions on respective ends of a headphone band that are movable via vertical movement mechanisms. The vertical movement mechanisms include a pair of suspending members provided on both sides of respective joint portions that are slidable in opposing directions, a holding means arranged between the suspending members, and a pair of rotating members. One end portion of the rotating members is attached to the holding means, which are rotatable via synchronous rotation means. One end portion of the respective rotating members rotatably attaches to a corresponding suspending member, so the holding means is movable in a vertical direction with respect to the suspending members via the rotating members.

### FIELD OF THE INVENTION

The present invention relates to collapsible-expandable headphones mounted on a head and intended for personal use in listening music, and so on.

### BACKGROUND ART

Headphones in general consist of a generally elastic and curved headphone band and headphone units attached to both ends of the headphone band. Foldable headphones e.g. which do not require so much space and are thus convenient for storage as well as for carrying around, while they are out of use.

Such foldable headphones are described e.g. in Publication of JP Patent Application in Foreign Language No. 2005-527134 (hereinafter referred to as Patent Document 1) and JP Utility Model Application Laid-Open Publication No. 62-44589 (hereinafter referred to as Patent Document 2). Of these prior art documents, Patent Document 1 discloses headphones being so structured that a headphone unit is folded at two points in the direction of curvature. On the other hand, Patent Document 2 discloses headphones being so structured that a headphone band is folded at three points in a direction perpendicular to the direction of curvature.

In foldable headphones described in Patent Document 1 as mentioned above a headphone band can be folded only at two points, so the problem lies in size of the headphones as folded which can only be reduced to a limited degree. In the ones described in Patent Document 2 a headphone band is folded at three points, so the headphones as folded is more compact than that of Patent Document 1. However, the problem lies in a complicated folding operation which leads to an additional problem of operability. Still further, as per headphone units, some do have indeed a simple structure, as are described in Patent Documents 1 and 2, but full-fledged headphone units are rather large-sized, which leads to a problem in compatibility with headphone units of simple structure as described in Patent Documents 1 and 2.

### SUMMARY OF THE INVENTION

The present invention is made to solve the above-mentioned problems, and an object of the invention is to provide headphones which can be collapsed into a more compact size than in conventional headphones and easily stored and carried around, as well as show an excellent operability in collapsing and expanding the headphones and is well compatible with full-fledged and large-sized headphone units.

To achieve the above-mentioned object, the present invention according to the first aspect relates to headphones in which headphone units are collapsibly and expandably attached to both sides of a headphone band. Here, each of the headphone units is attached to a corresponding one of joint portions provided on respective ends of the headphone band so as to be movable via a corresponding one of vertical movement mechanisms with respect to the joint portion, and each of the vertical movement mechanisms comprises a pair of suspending members provided on both sides of the corresponding one of the joint portions so as to be slidable in directions opposing to each other; a pair of rotating members, wherein one end portion of each of the rotating members is attached to said holding means, so as to be rotatable via synchronous rotation means, and other end portion of each of the rotating members is rotatably attached to a corresponding one of the suspending members. In this manner, the holding means is movable in a vertical direction with respect to the suspending members via the rotating members.

Next, the invention according to the second aspect is characterized in that a headphone band comprises a pair of elastic slide band portions and a housing portion for housing the elastic slide band portions respectively in its inside.

Still further, the invention according to the third aspect is characterized in that mono-directionally urging means are used for slidably attaching the suspending members on the opposite sides of the joint portion.

Still further, the invention according to the fourth aspect is characterized in that each of the mono-directionally urging means comprises a shaft portion provided on each side of the joint portion, a plunger portion fixed to the shaft portion, a slide cylinder portion, wherein the plunger portion is housed in its inside, and the slide cylinder portion is provided so as to be slidable in the right and left directions, and elastic means resiliently provided between the slide cylinder portion and the plunger portion.

Still further, the invention according to the fifth aspect is characterized in that the synchronous rotation means consist of wheel gears meshed with each other.

The invention is structured as described above, so that it shows effects that headphones are collapsed into a compact size while they are out of use, that their collapsing operation is easy, that their expanding operation from a collapsed state is easy as well, and that they are compatible with large-sized headphone units.

### BRIEF DESCRIPTION OF THE DRAWINGS

FIG. 1 is a perspective view of headphones according to the present invention in a state available for use;

FIG. 2 is a perspective view of headphones as shown in FIG. 1, in which the headphones are collapsed;

FIG. 3 is a perspective view illustrating a state in which expanding operation of the headphones is ongoing from a collapsed state as shown in FIG. 2, or their collapsing operation is ongoing from an expanded state;

FIG. 4 is a perspective view illustrating a state in which expanding operation of the headphones is ongoing from a collapsed state as shown in FIG. 3, or their collapsing operation is ongoing from an expanded state;

FIG. 5 is an exploded perspective view of a vertical movement mechanism of headphones according to the present invention;

FIG. 6 is an explanatory view of headphones according to the present invention, in particular of a vertical movement mechanism;

FIG. 7 is an explanatory view showing an operation of headphones according to the present invention, in particular of a vertical movement mechanism;

FIG. 8 is an explanatory view showing an operation of headphones according to the present invention, in particular of a vertical movement mechanism;

FIG. 9 is an explanatory view showing an operation of headphones according to the present invention, in particular of a vertical movement mechanism;

FIG. 10 is a perspective view of a joint portion of headphones according to the present invention;

FIG. 11 is a side view of a part of a vertical movement mechanism of headphones according to the present invention, as seen in a direction of arrow (a) in FIG. 6;

FIG. 12 is a cross-sectional view along a line A-A in FIG. 6;

FIG. 13 shows a plunger portion of headphones according to the present invention, FIG. 13A being a perspective view thereof as seen from one side, and FIG. 13B a perspective view thereof as seen from the other side;

FIG. 14 shows a slide cylinder portion of headphones according to the present invention, FIG. 14A being a perspective view thereof, and FIG. 14B a side view thereof;

FIG. 15 shows a suspending member of headphones according to the present invention, FIG. 15A being a perspective view thereof as seen from one side, and FIG. 15B a perspective view thereof as seen from the other side;

FIG. 16 shows a joint piece of headphones according to the present invention, FIG. 16A being a perspective view thereof as seen from one side, and FIG. 16B a perspective view thereof as seen from the other side;

FIG. 17 is a perspective view of an upper holding member of headphones according to the present invention, as seen from the backside;

FIG. 18 is a partial exploded perspective view of a lower holding member of headphones according to the present invention;

FIG. 19 is a perspective view of a holding member of headphones according to the present invention; and

FIG. 20 is a perspective view of a rotation support shaft of headphones according to the present invention.

### EMBODIMENTS

In the following reference is made to best modes of headphones according to the present invention, based on the drawings.

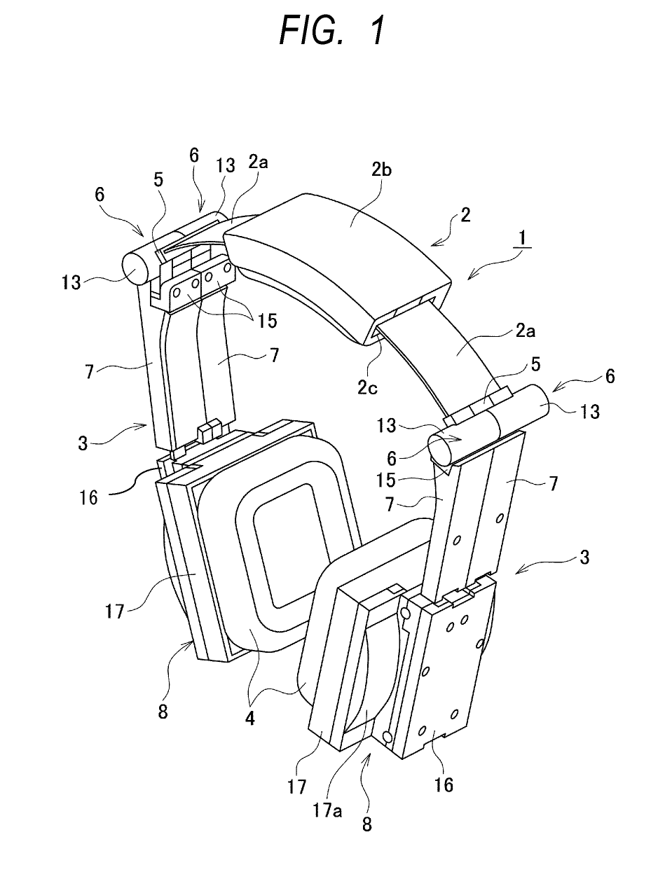

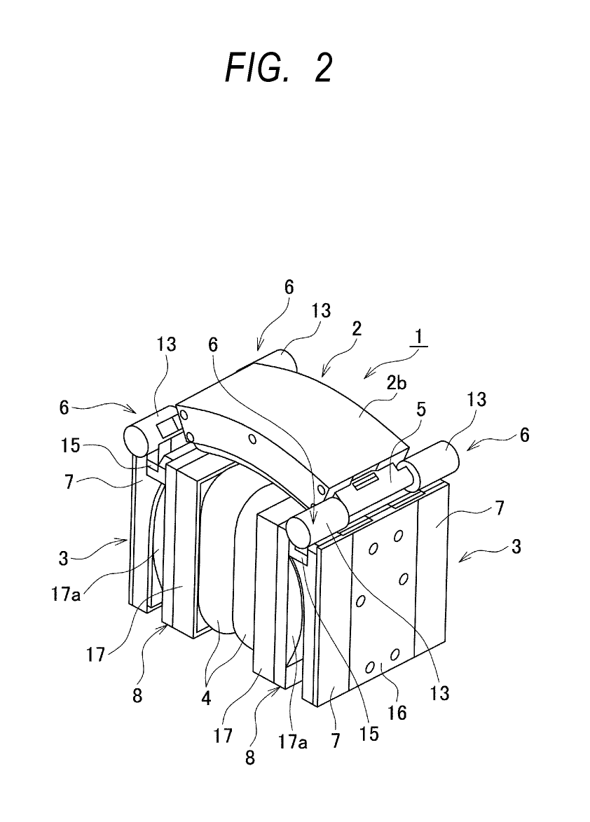

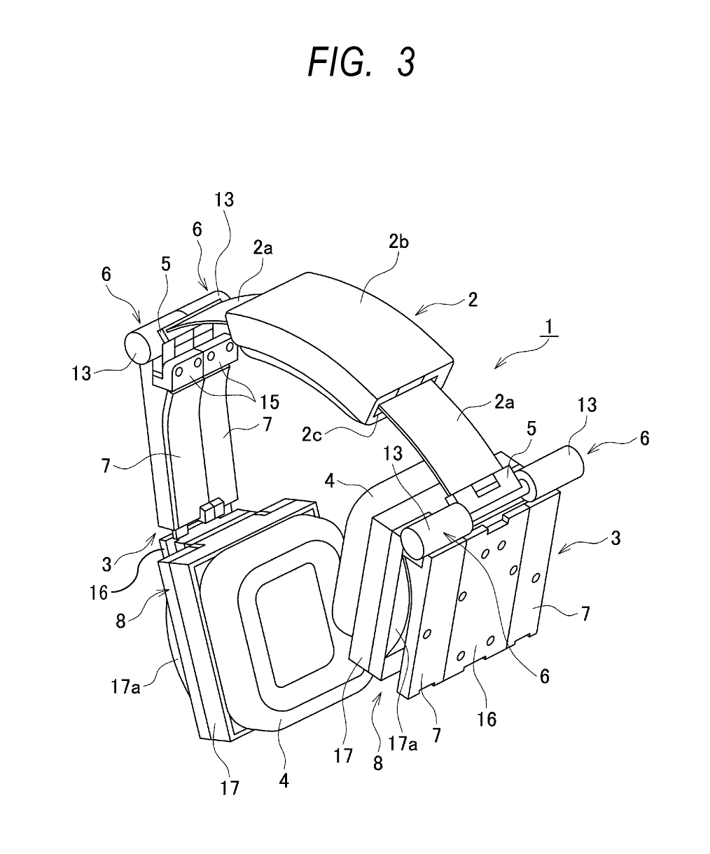

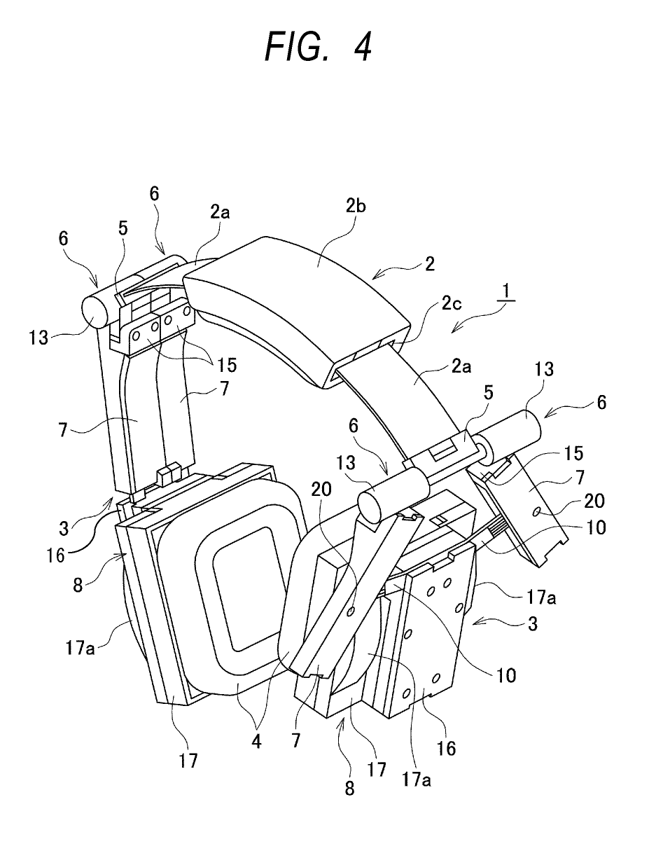

FIGS. 1 to 4 show headphones as a whole according to the present invention; FIG. 1 is a perspective view of headphones as expanded for a state available for use, and FIG. 2 is a perspective view of headphones as collapsed while they are out of use. FIGS. 3 and 4 are perspective views illustrating operation of a vertical movement mechanism, respectively from a collapsed state as well as from an expanded state.

According to FIGS. 1 to 4, headphones 1 according to the present invention comprise a headphone band 2 and a pair of headphone units 4, 4 attached to elastic slide band portions 2a, 2a of the headphone band 2 so as to be movable in a vertical direction via vertical movement mechanisms 3, 3. Each of vertical movement mechanisms 3, 3 comprises a pair of suspending members 7, 7 attached to joint portions 5, 5 via mono-directionally urging means 6, 6, holding means 8, 8 provided between the suspending members 7, 7 for holding the headphone units 4 4, and a pair of rotating members 10, 10, wherein one end portion of each of the rotating members is rotatably attached to the holding means 8, 8 via a synchronous rotation means 9 and the other end portion is rotatably attached to either one of the suspending members 7, 7, so that the holding means 8, 8 are movable in a vertical direction with respect to the suspending members 7, 7.

A headphone band 2, which has a curved profile as a whole in an expanded state, comprises elastic slide band portions 2a, 2a, wherein one end of portion of each of the elastic slide band portions 2a, 2a is attached to joint portions 5, 5 and a housing portion 2b for housing the respective other end portions of the elastic slide band portions 2a, 2a. Moreover, guide grooves 2c, 2c (of which only one is shown) is provided on the housing portion 2b. And then, the entire elastic slide band portions 2a, 2a are housed through the guide grooves 2c, 2c (of which only one is shown) into the housing portion 2b in a collapsed state, when headphones 1 are out of use, and the elastic slide band portions 2a, 2a are pulled out of the guide grooves 2c, 2c (of which only one is shown) in use, so that a headphone band 2 takes a curved shape as shown in FIGS. 1, 3 and 4.

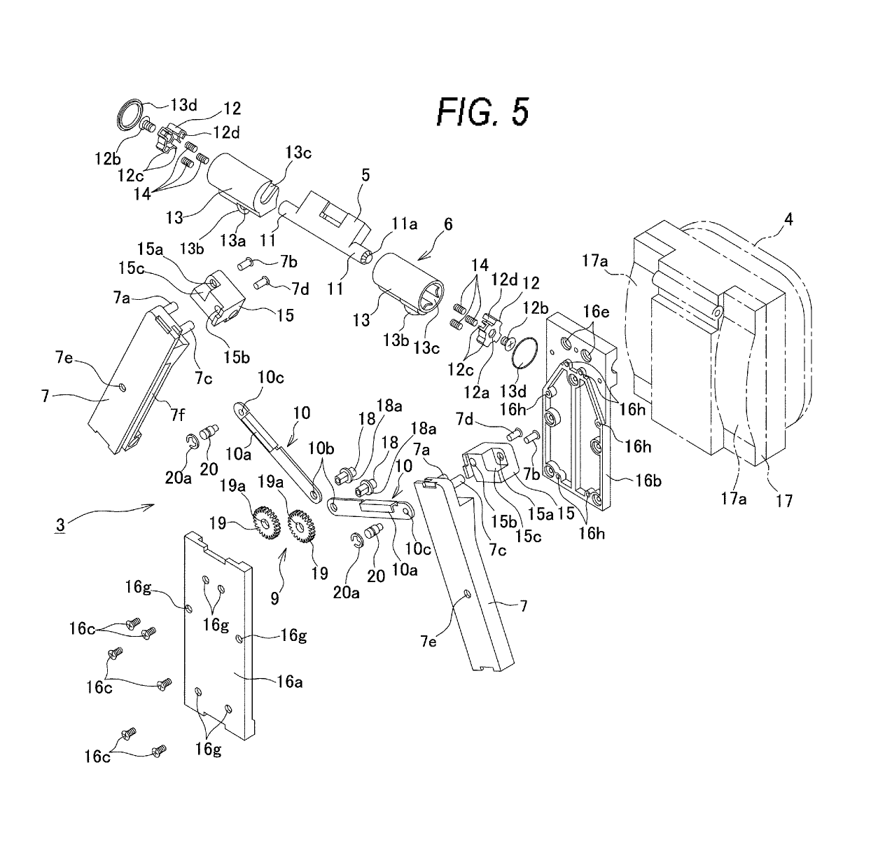

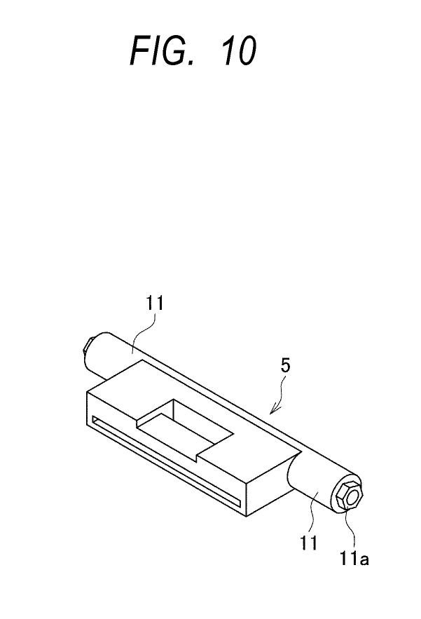

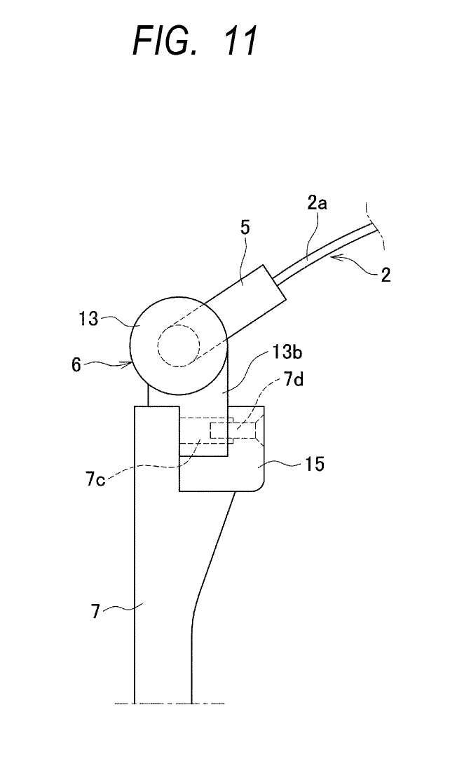

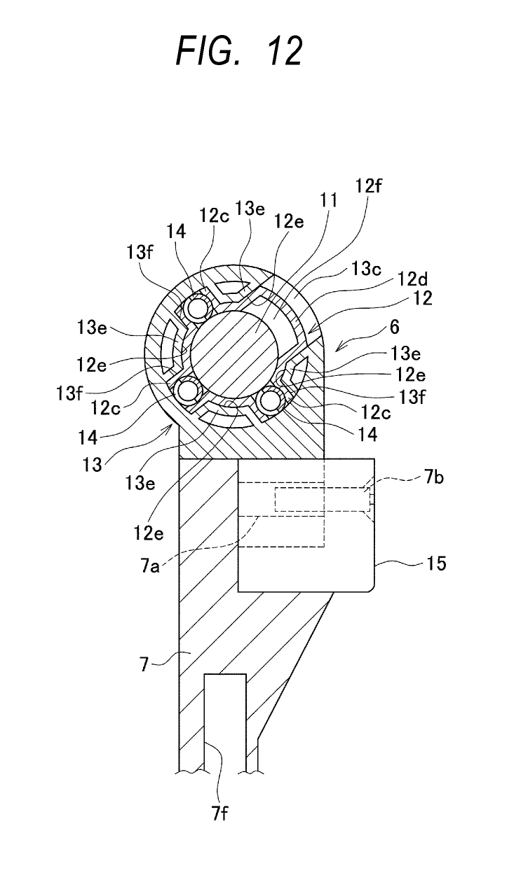

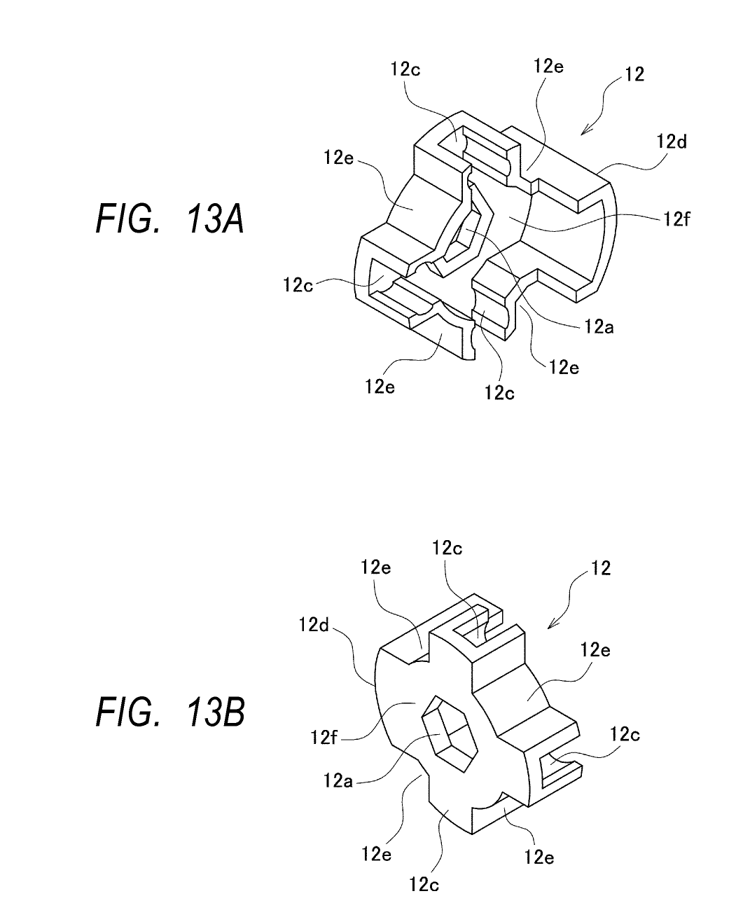

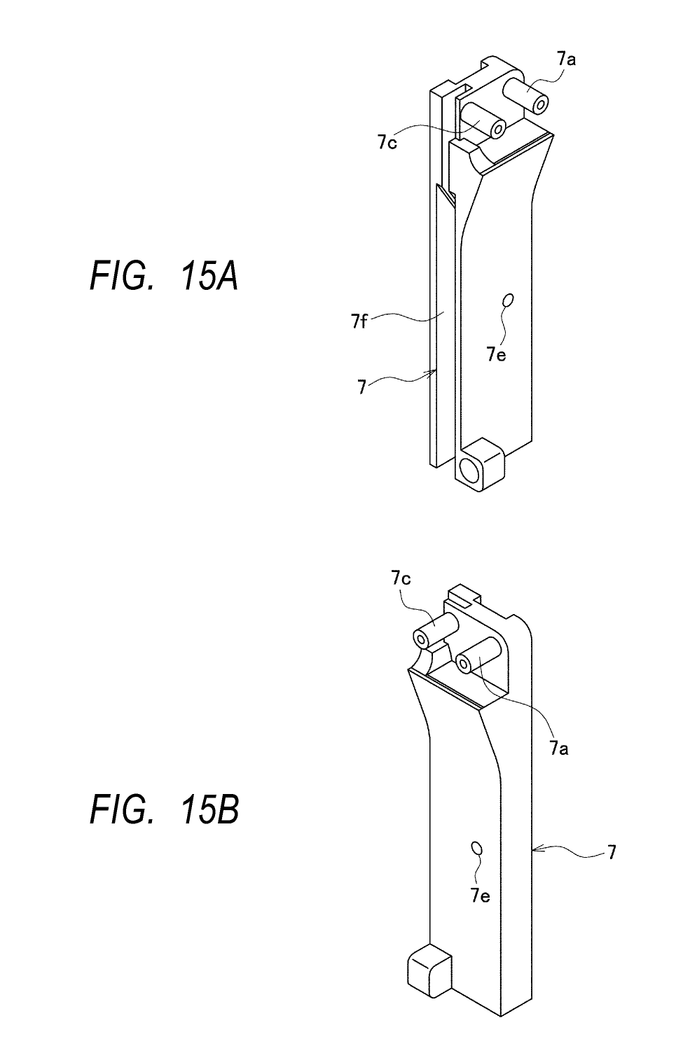

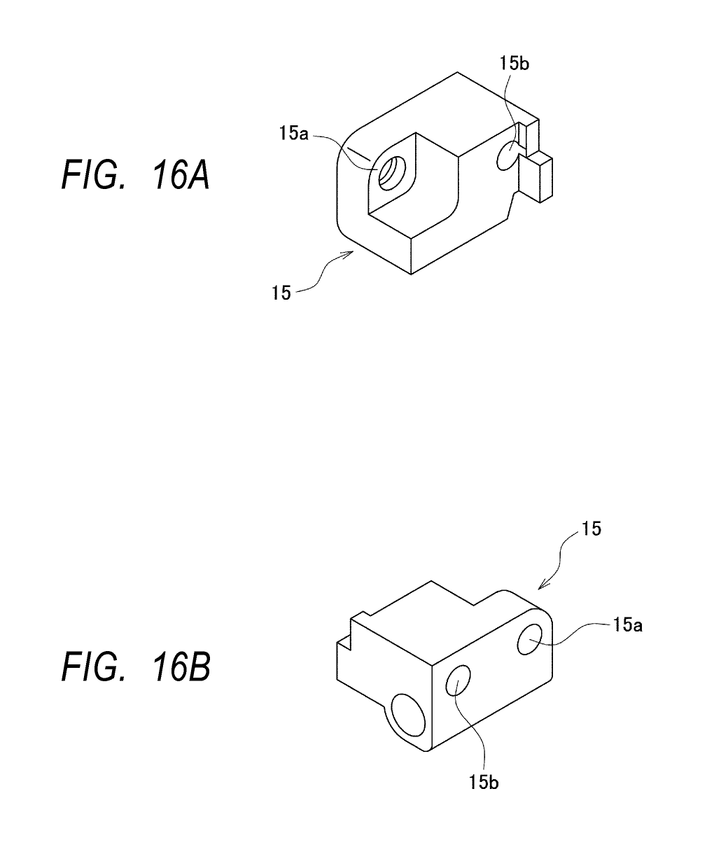

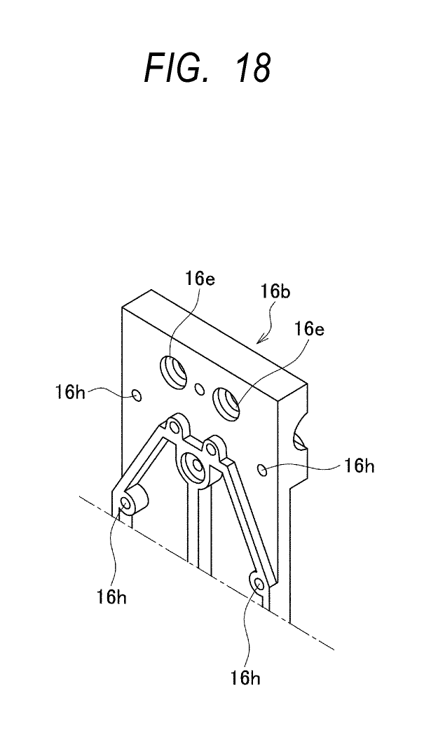

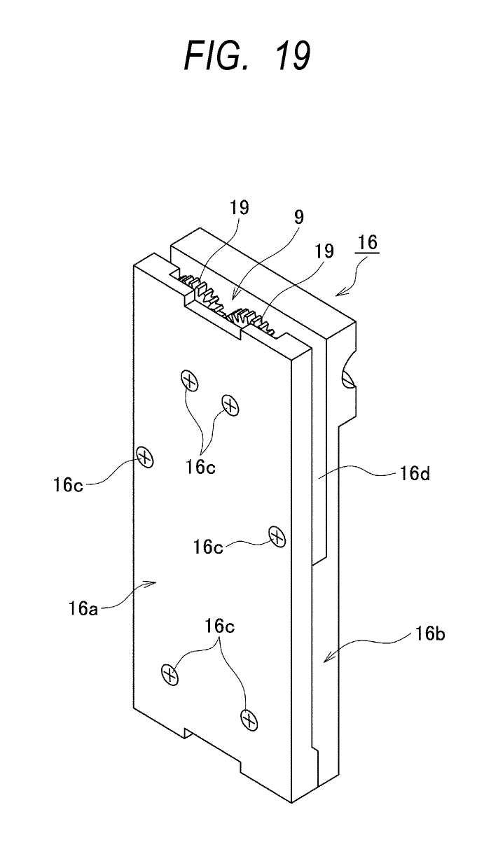

Given that vertical movement mechanisms 3, 3 of headphone units 4, 4 on the right and left have an identical structure, reference is made to only one of these mechanisms in the following. According to the drawings, especially as shown in FIGS. 5 to 20, the vertical movement mechanism 3 comprises mono-directionally urging means 6, 6 provided on both sides on one end portion of a joint portion 5 with the other end portion to which an elastic slide band portion 2a is attached, suspending members 7, 7 attached to the mono-directionally urging means 6, 6 via attaching pieces 15, 15, holding means 8, 8 of a headphone unit 4 provided between the suspending members 7, 7, rotating members 10, 10, wherein each of the rotating members 10, 10 is coupled to a corresponding one of the suspending members 7, 7 and to a holding members 16, 16 of the holding means 8, 8 and synchronous rotation means 9, 9 (of which only one is shown) wherein each of the synchronous rotation means is attached to the holding means 8, 8 (of which only one is shown) side of a corresponding one of the rotating members 10, 10 such that the rotating members 10, 10 rotate in a synchronized manner with each other.

As seen in detail, each of mono-directionally urging means 6, 6 comprises shaft portions 11, 11, wherein the shaft portions 11, 11 in pairs are provided on both side portions on the free end sides of a joint portion 5, plunger portions 12, 12 assembled by fitting deformed attaching portions 11a, 11a into deformed attaching holes 12a, 12a of the plunger portions 12, 12 and fixing the former to the latter via attaching screws 12b, 12b, slide cylinder portions 13, 13 assembled by housing the plunger portions 12, 12 in its inside and attaching the slide cylinder portions 13, 13 to the shaft portions 11, 11 so as to be slidable in an axial direction of the shaft portions, 11, 11, and elastic means 14, 14, 14; 14, 14, 14 being three compression coil springs which are resiliently provided between the slide cylinder portions 13, 13 and the plunger portions 12, 12.

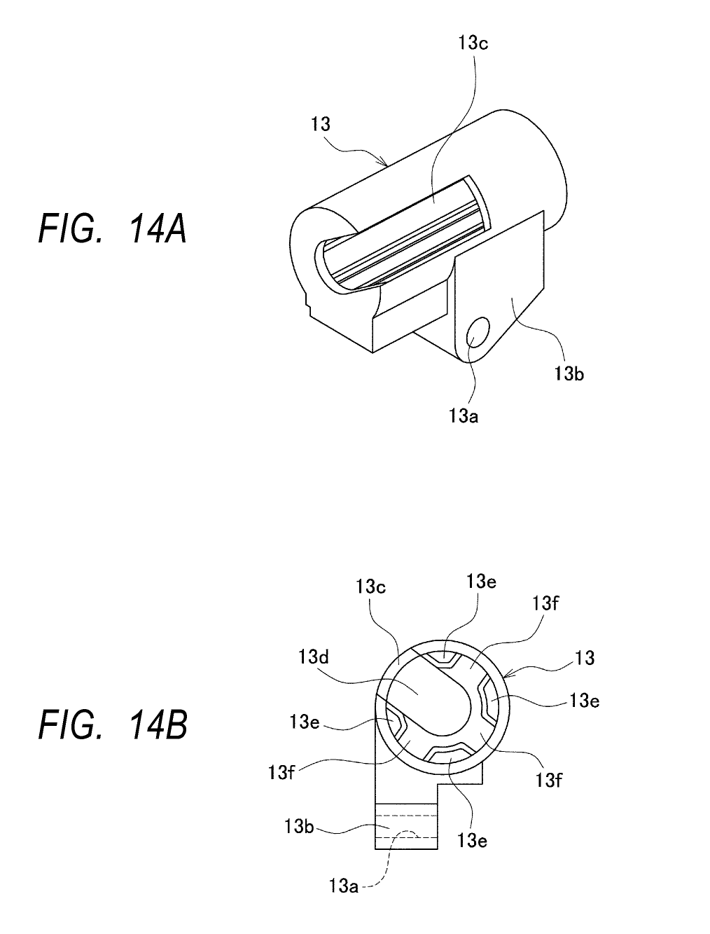

As seen further in detail, three spring housing portions 12c, 12c, 12c; 12c, 12c, 12c and cover portion 12d, 12d are provided radially around shaft centers of each plunger portions 12, 12 such that each adjacent ones of the spring housing portions and the cover portion 12d, 12d are arranged at regular intervals from base plate portions 12f, 12f, and guide groove portions 12e, 12e, 12e, 12e; 12e, 12e, 12e, 12e (in total four on one plunger portion) are provided between each adjacent ones of the spring housing portions and the cover portion. Attaching portions 13b, 13b equipped with attaching holes 13a, 13a are provided on an outer circumference of each slide cylinder portions 13, 13, while projecting portions 13e, 13e, 13e, 13e; 13e, 13e, 13e, 13e which are fitted into guide groove portions 12e, 12e, 12e, 12e; 12e, 12e, 12e, 12e of each plunger portions 12, 12 are provided on an inner surface of a part housing the shaft portion. In this manner, each of the slide cylinder portions 13, 13 and each of the plunger portions 12, 12 are fitted with each other, so that a rotation of each slide cylinder portions 13, 13 around the corresponding plunger portions 12, 12 can be prevented. Still further, guide grooves 13c, 13c for allowing a joint portion 5 to enter into the guide groove while each slide cylinder portion is sliding is provided on a portion of an outer circumference of each slide cylinder portions 13, 13. Still further, cover portions 12d, 12d are provided on each plunger portions 12, 12 so as to hide the interior of each slide cylinder portions 13, 13, when guide grooves 13c, 13c escape from the joint portion 5. Still further, reference numeral 13d denotes a cover member, and the ones having reference numerals 13f, 13f, 13f are housing portions, in particular in FIG. 14. In addition, elastic means 14, 14, 14; 14, 14, 14 being three compression coil springs are housed in the spring housing portions 12c, 12c, 12c; 12c, 12c, 12c of each plunger portion 12, so that the elastic means slidably urge each slide cylinder portions 13, 13 toward the joint portion 5.

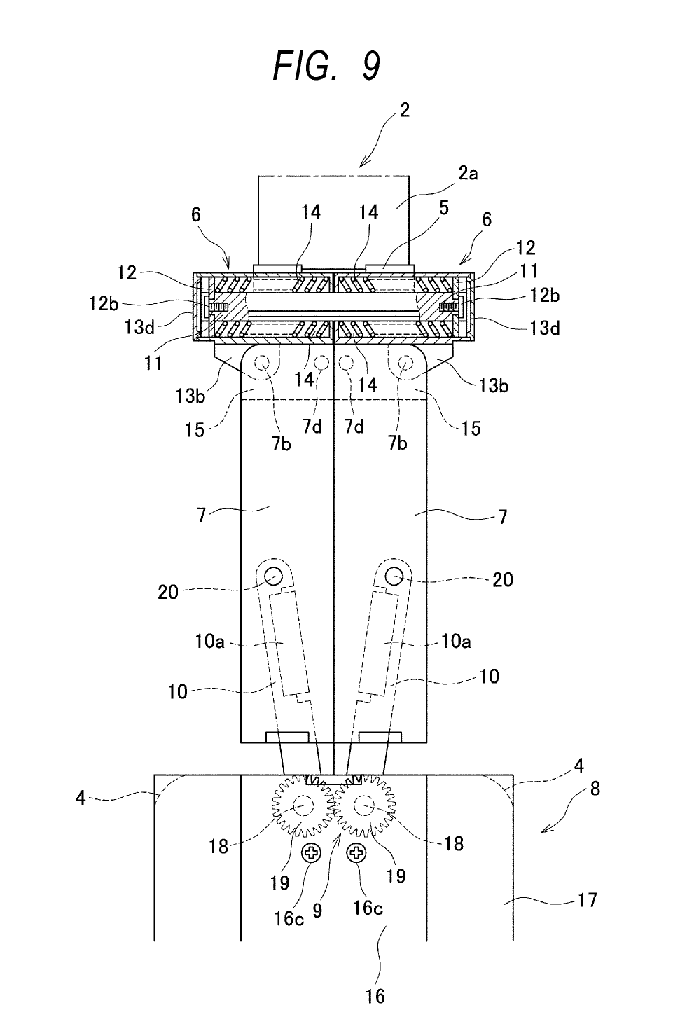

In the meantime, if mono-directionally urging means 6, 6 are provided, this enables suspending members 7, 7 to automatically return to their original position as shown in FIG. 9, in case of pressing a holding member 16 downward, as described below, which further results in an improved operability. However, even if mono-directionally urging means 6, 6 are omitted, suspending members 7, 7 can also return to their original position.

Still further, elastic means 14, 14, 14; 14, 14, 14 on each side consist of three compression coil springs in the drawings, but the number of the compression coil springs is not particularly limited. Two or more than three compression coil springs are allowed.

Still further, an arrangement so as to prevent a rotation of slide cylinder portions 13, 13 is not limited to the one in the drawings. The arrangement may undergo design changes which are easily conducted on the part of a skilled person in the art, depending on the number of compression coil springs serving as elastic means.

Next, each of suspending members 7, 7 is attached to the corresponding one of attaching portions 13b, 13b of slide cylinder portions 13, 13, via the corresponding one of joint pieces 15, 15. In other words, two joint holes 15a, 15b; 15a, 15b are respectively provided on each of joint pieces 15, 15; joint pins 7a, 7a provided on each of the suspending members 7, 7 is inserted into the corresponding one of attaching holes 13a, 13a provided on the attaching portions 13b, 13b of the slide cylinder portions 13, 13, and thus rotatably coupled to the corresponding one of the joint holes 15a, 15a provided toward respective joint recess portions 15c, 15c of respective joint pieces 15, 15, using the corresponding one of attaching screws 7b, 7b. On the other hand, joint pins 7c, 7c provided on each of the suspending members 7, 7 are inserted into the corresponding one of other joint holes 15b, 15b and attached to the latter using the corresponding one of attaching screws 7d, 7d. Each of suspending members 7, 7 is provided with attaching holes 7e, 7e for pivotally attaching the corresponding one of rotating members 10, 10 on one side of a central portion, as well as with slits 7f, 7f for housing the corresponding one of rotating members 10, 10 from one side of a side portion toward the inside.

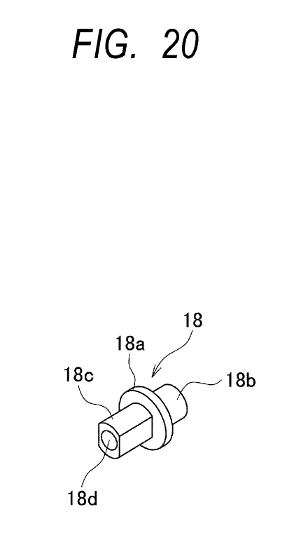

A holding means 8 comprises a holding member 16 assembled by overlapping an upper holding member 16a and a lower holding member 16b, wherein both members are fixed to each other with attaching screws 16c, 16c, 16c, . . . screwed into respective attaching holes 16h, 16h, 16h, . . . , and an attaching member 17 attached to the holding member 16. A headphone unit 4 is attached to the attaching member 17. A slit 16d into which rotating members 10, 10 enter and from which they project outside is provided on an upper portion corresponding to the upper holding member 16a and the lower holding member 16b as overlapping each other. A pair of rotation support shafts 18, 18 is rotatably provided on an upper portion of the holding member 16, and a tip of each of the rotating members 10, 10 is attached to the corresponding one of the rotation support shafts 18, 18, such that the tip can rotate together with the latter. Still further, a pair of wheel gears 19, 19 are attached to the respective rotation support shafts 18, 18 such that each of the wheel gears 19, 19 can rotate together with the corresponding one of the rotation support shafts 18, 18, and the wheel gears 19, 19 are meshed with each other, so that the wheel gears represent a synchronous rotation means 9 as described above. Moreover, especially as shown in FIG. 20, circular smaller diameter portions 18b, 18b and deformed smaller diameter portions 18c, 18c are provided on the front and rear portions over flange portions 18a, 18a on each of the rotation support shafts 18, 18. The circular smaller diameter portions 18b, 18b on one side is pivotally supported together with the flange portions 18a, 18a so as to be rotatable in the corresponding one of the stepped holes 16e, 16e provided on the upper holding member 16a, while the deformed smaller diameter portions 18c, 18c on the other side is engaged with the corresponding one of the deformed attaching holes 10b, 10b provided on the rotating members 10, 10, as well as with the corresponding one of the deformed attaching hole 19a, 19a provided on the wheel gears 19, 19.

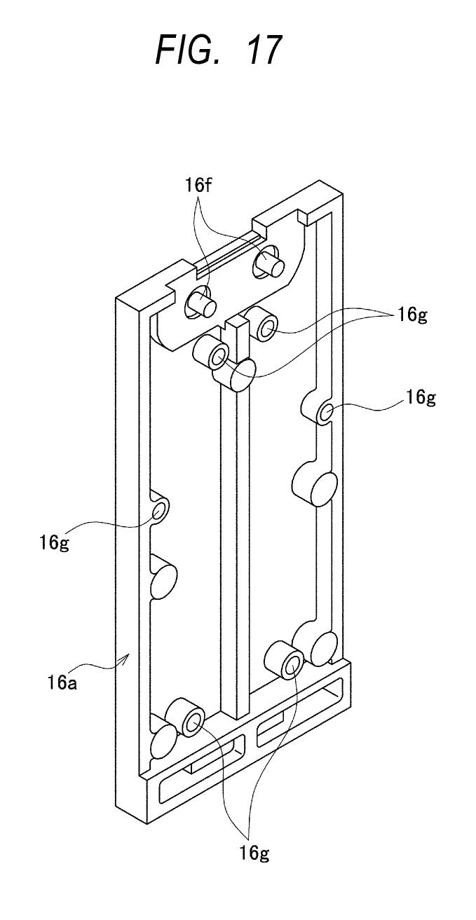

Still further, each of pivotally supported holes 18d, 18d is provided on a corresponding one of deformed smaller diameter portions 18c, 18c, and is pivotally supported by a corresponding one of supporting shafts 16f, 16f (shown in FIG. 17) provided on an upper holding member 16a. In this manner, rotating members 10, 10 are so structured that they rotate together via wheel gears 19, 19 being a synchronous rotation means 9. In the meantime, the layout of a holding means 8 is not limited to the one in the embodiment. For example, headphone units 4 can be directly attached to a holding member 16.

Each of rotating members 10, 10 has an elongated plate-like shape with the corresponding one of bent portions 10a, 10a on one side for reinforcement. Moreover, each of rotating members is so structured that deformed attaching holes 10b, 10b engaging with the corresponding one of deformed smaller diameter portions 18c, 18c of rotation support shafts 18, 18 is provided on one end as described above, and that each of the rotating members 10, 10 is rotatably attached to the corresponding one of attaching holes 7e, 7e provided substantially on a central portion of suspending members 7, 7, via the corresponding one of attaching pins 20, 20 inserted into the corresponding one of attaching holes 10c, 10c. In the meantime, reference numerals 20a, 20a denote E-rings for locking the respective attaching pins 20, 20 to an upper holding member 16a.

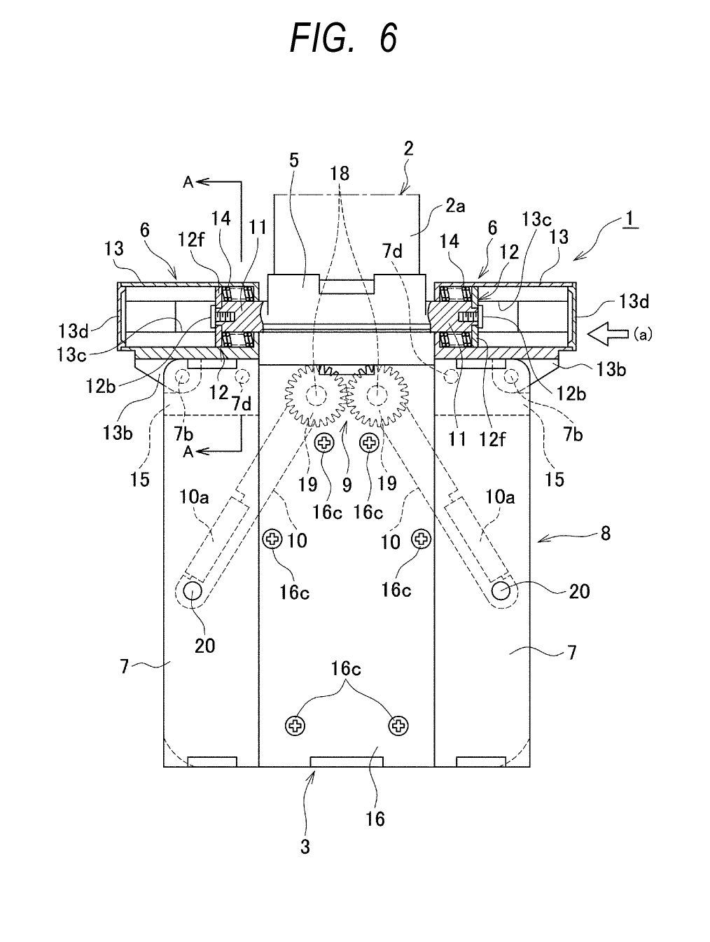

In the following, reference is made to effects of the headphones 1 according to the present invention, based on what is described above and accompanying drawings. In the meantime, FIGS. 6 to 9 are explanatory views illustrating in particular operation of one of the vertical movement mechanisms 3, 3 of the headphones 1 according to the present invention, and, being cross sectional views, do not precisely reproduce the cross sectional direction of the mono-directionally urging means 6, 6 in particular.

The headphones 1 according to the present invention is so structured that, when they are in use, the respective elastic slide band portions 2a, 2a are pulled out of the housing portion 2b of the headphone band 2, and the headphone units 4, 4 are pulled downward via the vertical movement mechanisms 3, 3 with respect to the joint portions 5, 5 of the headphone band 2, together with the holding means 8, 8, as shown in FIG. 1. Should the headphones 1 out of use be folded into a compact size, the headphone units 4, 4 are pulled upward together with the holding means 8, 8 using the vertical movement mechanisms 3, 3 toward the joint portions 5, 5, and the elastic slide band portions 2a, 2a are housed into the housing portion 2b. In this manner, the headphones 1 as a whole are folded into a small and compact size as shown in FIG. 2. The movement of the respective components at the time of folding and expanding operations is shown in FIGS. 3 and 4.

In the following, reference is made to the operation of the vertical movement mechanisms 3, 3. Given that the vertical movement mechanisms 3, 3 of headphone units 4, 4 on the right and left have an identical structure, and thus have an identical operation, reference is only made to the vertical movement mechanism 3 shown on the right hand side in FIG. 1 in the following.

First, prior to the operation of the vertical movement mechanism 3, the holding member 16 lies toward the joint portion 5, and on its both sides, the suspending members 7, 7 abut against each other on the both sides of the holding member 16, as shown in FIG. 6. In this state, the rotating members 10, 10 are housed in the slits 7f, 7f of the suspending members 7, 7 and the slit 16d of the holding member 16. Moreover, as per the mono-directionally urging means 6, 6, the slide cylinder portions 13, 13 slide in such directions that both are spaced apart with respect to the shaft portions 11, 11, and the elastic means 14, 14, 14; 14, 14, 14 is in a contracted state between the plunger portions 12, 12, so as to urge the slide cylinder portions 13, 13 toward the joint portion 5. Accordingly, the holding member 16, as sandwiched between the suspending members 7, 7, does not move downward due to own weight. Still further, the synchronous rotation means 9 side of each of the rotating members 10, 10 is located on an upper side, and the joint section of each of the suspending members 7, 7 on a lower side.

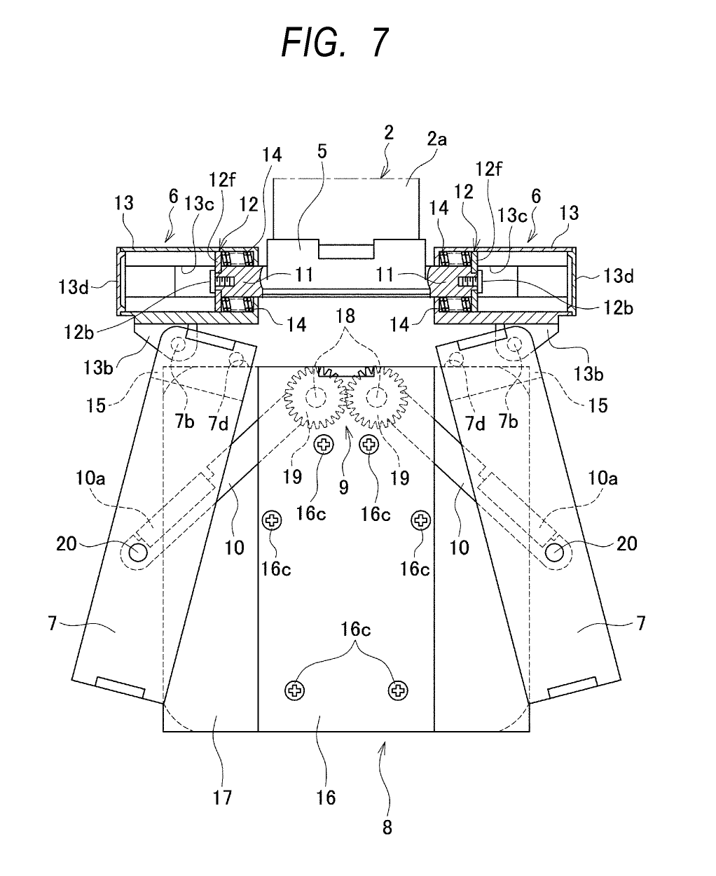

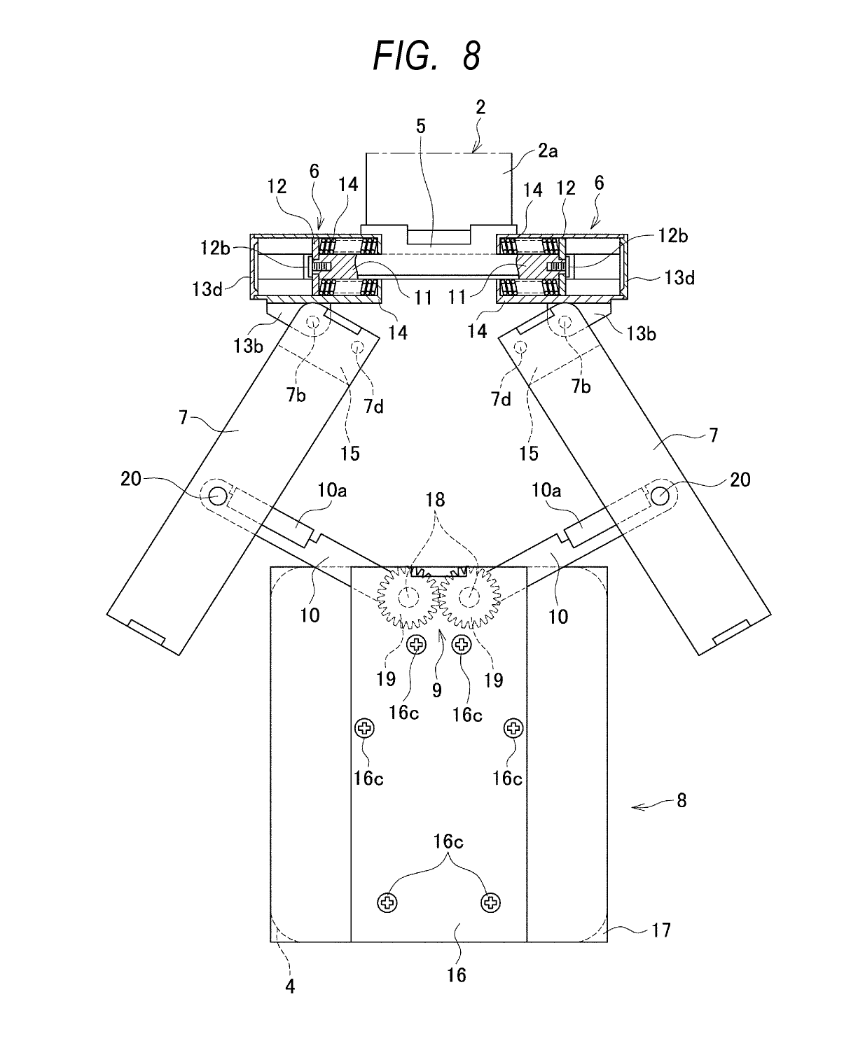

When a projecting portion 17a, 17a (of which only one is shown) provided on the attaching member 17 of the holding means 8 is held by fingers and pulled downward from this state, the rotating members 10, 10 simultaneously assume rotation via the synchronous rotation means 9, the holding member 16 moves downward, with opening the suspending members 7, 7 to the right and left, with their attaching points to the attaching portions 13b, 13b being supporting points. This state is shown in FIG. 7. When the attaching member 17 is further pulled downward from this state, the suspending members 7, 7 continue their rotation, and stop where the holding member 16 lies below the lower end portion of the suspending members 7, 7. This state is shown in FIG. 8. At this point, the suspending members 7, 7 escape from the holding member 16 which prevents the suspending members from moving to the central portion, so that the suspending members automatically return to their original positions due to the elastic force of the elastic means 14, 14, 14; 14, 14, 14 of the mono-directionally urging means 6, 6, in order to stop by abutting against each other. This state is shown in FIG. 9. Once the similar operation is made to another headphone unit 4, the headphones 1 according to the present invention regain their state available for use as shown in FIG. 1 from the collapsed state for storage or carrying around. As described in the foregoing, the synchronous rotation means 9 and the rotating members 10, 10 of the vertical movement mechanism 3 prevent the holding member 16 from wobbling in its symmetrical operation together with the headphone unit 4, and enable the holding member to move vertically.

Should the headphones 1 be again folded into a compact size from the state available for use, either one of the suspending members 7, 7 is opened outward. In this manner, another suspending member 7 is as well opened outward with help of the synchronous rotation means 9, and the holding member 16 is pushed upward by means of the rotating members 10, 10. Once the holding member 16 is further pulled upward from this state, the suspending members 7, 7 are opened outward to allow for upward movement of the holding member 16, and stop by abutment of both ends of the holding member 16 with the rotating members 10, 10, in order to return to the collapsed position. And then, the elastic slide band portion 2a is housed in the housing portion 2b, which marks the end of the folding operation of the one headphone unit 4, and the headphones 1 are collapsed into a compact size by similarly operating another headphone unit 4 as shown in FIG. 2.

The present invention is structured as in the foregoing, so that it is suitable for use as headphones can be folded into a compact size and carried around while they are out of use, and show an improved operability in collapsing and expanding operations in use as well as out of use.

What is claimed is:

1. Headphones in which headphone units are collapsibly and expandably attached to both sides of a headphone band,
each of said headphone units being attached to a corresponding one of joint portions provided on respective ends of said headphone band so as to be movable via a corresponding one of vertical movement mechanisms with respect to said corresponding one of joint portions;
each of said vertical movement mechanisms comprising:
a pair of suspending members provided on both sides of said corresponding one of joint portions so as to be slidable in directions opposing to each other;
a holding means arranged between said suspending members for respectively holding one of said headphone units; and
a pair of rotating members, one end portion of each of said rotating members being attached to said holding means, so as to be rotatable via synchronous rotation means, and other end portion of each of said rotating members being rotatably attached to a corresponding one of said suspending members;
said holding means thus being movable in a vertical direction with respect to said suspending members via said rotating members.

2. The headphones according to claim 1, wherein said headphone band comprises a pair of elastic slide band portions and a housing portion for housing said elastic slide band portions respectively in the inside of said housing portion.

3. The headphones according to claim 1, wherein mono-directionally urging means are used for slidably attaching said suspending members on the opposite sides of said joint portion.

4. The headphones according to claim 1, wherein each of said mono-directionally urging means comprises a shaft portion provided on each side of said joint portion, a plunger portion fixed to said shaft portion, a slide cylinder portion with said plunger portion being housed in the inside of said slide cylinder portion, said slide cylinder portion being provided so as to be slidable in the right and left directions, and elastic means resiliently provided between said slide cylinder portion and said plunger portion.

5. The headphones according to claim 1, wherein said synchronous rotation means consist of wheel gears meshed with each other.
